(19) United States
(12) Patent Application Publication
(10) Pub. No.: US 2013/0260898 A1
(43) Pub. Date: Oct. 3, 2013

(54) FANTASY SPORTS GAME

(71) Applicants: James Pepe, Miami Beach, FL (US); Vincent K. Calitri, Mahwah, NJ (US)

(72) Inventors: James Pepe, Miami Beach, FL (US); Vincent K. Calitri, Mahwah, NJ (US)

(21) Appl. No.: 13/851,814

(22) Filed: Mar. 27, 2013

Related U.S. Application Data
(60) Provisional application No. 61/616,088, filed on Mar. 27, 2012.

(51) Int. Cl. A63F 13/00

(52) U.S. Cl. CPC A63F 13/00
USPC 463/42

(57) ABSTRACT

A fantasy sports game is presented in which participants act as “managers” to build or draft teams that compete against each other based on the statistics generated by the actual individual players or teams of a sport, whether professional, college, Olympic, or amateur. Unlike traditional fantasy sports platforms, in which participants of the game freely draft players, in turn, according to their respective strategies and preferences, the present invention comprises a pre-determined, position based “lead pick-forced pick” feature in which draft selections or picks and counter-picks are “linked” based on on-field positions of the respective sport. All forced picks are therefore based on limited discretion—a forced pick must select a pre-determined position player from the actual sports team that is opposing the team of the player the subject of the immediately preceding lead or smash pick. Participants and their teams then amass points based on the performance of the athletes on their roster in their regularly scheduled league game and according to pre-determined rules of the particular league employing the invention game.

### RELATED APPLICATION

This application is the Non-Provisional Application of Provisional Application No. 61/616,088, filed on Mar. 27, 2012 for “Turn-Based, Asynchronous Interactive Fantasy Sports Game” by James Pepe and Vincent K. Calitri. This Non-Provisional Application claims priority to and the benefit of that Provisional Application, the contents and subject of which are incorporated herein by reference in their entirety.

### TECHNICAL FIELD

The present invention relates to a fantasy sports game in which participants act as “managers” to build or draft teams that compete against each other based on the statistics generated by the real individual players or teams of a sport, whether professional, college, Olympic, or amateur.

### BACKGROUND

A fantasy sport (also known by other names, such as, for example, rotisserie, roto, virtual, or owner simulation sport) is a game where participants of the game act as “owners” or “managers” to build a team that competes against other fantasy owners based on the statistics generated by the real individual players or teams of an actual team based sport, usually, but not always, a professional sport. Probably the most common variant converts statistical performance into points that are compiled and totaled according to a roster selected by the owner/manager (i.e., participant of the fantasy game) that makes up a fantasy team. These point systems are typically simple enough to be manually calculated by a “league commissioner.” More complex variants use computer modeling of actual games based on statistical input generated by the sport, usually a professional sport. In fantasy sports, based on variant league rules, there may be the ability to trade, cut, and sign players, like a real sports team owner.

It is estimated by the Fantasy Sports Trade Association (the “FSTA”) that 32 million people age 12 and above in the U.S. and Canada played fantasy sports in 2010. Participation has grown over 60 percent the past four years with 19 percent of males in the U.S. playing fantasy sports. A prior study by the FSTA showed 19.4 million people age 12 and above in the U.S. and Canada played fantasy sports in 2006 and 34.5 million people had ever played fantasy sports. A 2006 study showed 22 percent of U.S. adult males 18 to 49 years old, with Internet access, play fantasy sports. Fantasy sports is estimated to have a $3-$4 billion annual economic impact across the sports industry.

The hobby has also moved beyond the U.S., with fantasy leagues for soccer, cricket and other sports. For example, according to a 2008 study by Ipsos, the number of British fantasy sports players aged 16-64 is estimated to range between 5.5 and 7.5 million. Of those, 80 percent of these players participate in fantasy soccer.

Probably the single most significant factor contributing to the immense growth and popularity of fantasy sports was the increased development and availability of the Internet, a global, digital communications network, in the mid-1990s and the subsequent growth of mobile technologies over the past 10 years. These new technologies have lowered the barrier to entry to the hobby, as statistics could quickly be compiled online and news and information became readily available, including by and through mobile applications or “apps.”

While several fantasy businesses had migrated to the Internet in the mid-1990s, a noteworthy milestone for online fantasy sports was in 1997 when two web sites made their debut that changed the fantasy sports industry: Commissioner.com and RotoNews.com. Soon after, other larger media players also implemented fantasy sports into their online platforms. Yahoo.com added fantasy sports in 1999 and offered most of its games for free—a largely new business model for fantasy sports.

While fantasy sports indeed apply or may be applied to virtually any sport, in the U.S., fantasy football is exceptionally popular and was the first such based fantasy sport, with roots going back to the early 1960s. Fantasy football is an interactive competition in which users compete against each other as general managers of virtual teams. The players that an individual is able to draft, manage and play are actual professional football players in the National Football League (the “NFL”), although fantasy football leagues may be established upon college footballs teams and players as well. The different actions that may be taken by participants of fantasy football include, but are not limited to, drafting, trading, adding or dropping players, and changing rosters. Due to the growth of the Internet and resultant mobile technologies, fantasy football has vastly increased in popularity, particularly because fantasy football providers such as ESPN, Yahoo, CBS, and the NFL itself are able to keep track of statistics entirely online, eliminating the need by users or participants of the game to check box scores and newspapers regularly to keep track of players, scoring, statistics, injuries, etc. (As used herein, the terms “participant” and “users” may be used interchangeable and mean the actual individual participants of the invention game—whether actual persons or “bots”—and the terms “player” and “players” refers to the actual, real-life players of the actual sport upon which the fantasy game is based).

There are several different types of fantasy football leagues. Two popular fantasy football formats are: head-to-head and total points leagues. Some fantasy football league types or formats include the following (of which there may be variations and combinations thereof, depending on a particular league):

Head-to-Head Leagues.

In head-to-head leagues, a team matches up versus a different team each week. The team that receives the most points of the two receives a win for that particular week. Points are dictated by the scoring system that is either standard set by the website or custom set by a league's commissioner. A team's total is the sum of all players' points in the starting lineup. The win-loss record is the most important statistic in head-to-head leagues, as it directly correlates with the league champion. Teams with the best win-loss record advance to the playoffs. If two teams have the same record, various tie-breaker rules are used to decide which team advances within the playoffs, as those rules are established by the league or the league's commissioner.

Total Points Leagues.

Total points leagues are leagues in which teams accumulate points on an ongoing basis. The league standings are determined by the teams'total points rather than their win-loss record. The teams that accrue the highest total of points throughout the duration of the NFL-regular season advance to the playoffs.

Dynasty “Keeper” Leagues.

A dynasty “keeper” style fantasy football league is a league where participants (teams) retain most or all of their players from year to year. This creates an environment which is very different from that of a redraft league, i.e., a league where teams are drafted from scratch on an annual basis—usually during the NFL pre-season and close to the first week of regular season play. In such leagues, the type of players available in the yearly draft is focused more towards rookies with long-term potential.

Salary Cap Leagues.

The salary cap football league is a particular type of dynasty league which adds another factor of realism similar to the NFL: the salary cap. Just like in the NFL, this means each player has an associated salary and the total spent on all the players on a team has a maximum—i.e., a “salary cap.” This type of league can have many levels of complexity, e.g., a player may be signed for multiple years, etc.

Auction Leagues.

In an auction league, general manager or team owners “nominate” players (in order) to be bid on by all team general managers or owners in the league. Each franchise has a “cap,” for example, $200,000.00, that it can spend on its entire roster. This is similar to a salary cap league in that the amount that any team may spend on players is “capped,” but in an auction league, there is no set price on any individual player—that is determined by auction.

Daily Fantasy Sports.

Daily fantasy sports is like traditional fantasy sports where participants draft a team of real world athletes who then score fantasy points according to set scoring rules. However, instead of owning and managing the same team roster through an entire season, daily fantasy sports contests last just one day (or in the case of the NFL, one weekend). Users can play head-to-head or in larger field tournaments. As such, teams must be periodically drafted throughout the season, thereby providing parity into the system. In the case of an NFL-based daily fantasy sports league, teams must be drafted once each week during the NFL season and the draft must take place before the first game of the week is played, which sometimes falls on a Thursday (typically, most NFL games are played on Sundays; however, occasionally one or more games may be played on a Thursday. In addition, each NFL week includes a Monday night game for that week).

Playoff Fantasy Football.

Several websites, including NFL.com, offer a fantasy football league during the NFL's playoffs. Participants choose players from several different positions and receive points each week for their performances. The league lasts until the Super Bowl. Players who are on a fantasy roster for consecutive weeks earn double, triple, and finally quadruple points. Scoring is usually the same as in most season-long leagues.

New league types.

A new style of fantasy football is modeled after the popular “survivor pool” or “knock out pool” style of weekly NFL wagering that allows each pool member to pick one NFL team to win each week, but he or she can only pick that team once all year. Similarly, survivor fantasy leagues allow owners to draft a fresh team of seven players each week, with each player only available to each owner one week per year. This added level of strategy places an emphasis on weekly NFL match ups, while at the same time diminishing the negative consequences of injuries.

The popularity of fantasy football has filtered down into the collegiate level as well. Fantasy college football is gaining in popularity as diehard fantasy players and college football fanatics combine two of their favorite passions into one. The most popular leagues involve the BCS (Bowl Championship Series) only schools while other leagues incorporate all FBS (Football Bowl Subdivision) schools or even just the “non-BCS” schools.

While there are many variations and formats of fantasy football—and all fantasy sports—which may incorporate one or more attributes of the above described formats (or any combination thereof), an overriding theme of each format is that participants of the game freely draft players, in turn, according to their respective strategies and preferences. The present invention, with its pre-determined, position based “lead pick-forced pick” feature provides an entirely novel format to fantasy sports. Indeed, this feature, and many others described below, create a fantasy sports game where the draft portion is as much of the game as the actual individual team match-ups that determine points accrued and the winner of a respective game.

### SUMMARY

The invention that is the subject of this application is an interactive fantasy football game employing a turn-based, asynchronous model that may be played between two (2) or more participants. As used herein, a “participant” or “user” of the game may be an individual (real person) or a “bot” (software program), or any combination thereof, and the game may be played using electronic mobile devices (such as cell phones, smart phones, pads, etc.), computers, laptops and any other electronic device capable of communicating with any other electronic device (currently existing or as may come into existence in the future) via the Internet or any other wired or wireless communications network system using well-established protocols generally known to those in the industry, currently existing or as may be established in the future. A novel feature of the invention, among others, is its turn-based, asynchronous game model. Standard “fantasy” based games, such as, but not including, fantasy football, often require that the draft portion be conducted as a single event at a predetermined time (e.g., Saturday, August 28 at 2:00 PM at Joe Smith's house) with all league participants present—either physically or via network connections—in order to conduct an expeditious and orderly draft of players. In addition, the game is not just the fantasy version of the reality games upon which it is based, but the game also comprises the “drafting” mechanism or portion, as described further herein.

Significantly, while the term “fantasy football” is used throughout this description to demonstrate a particular embodiment of the invention that is based on the game of football, in general, and the NFL, in particular, that term is expressly intended not to be limited only to the football. Rather, “fantasy football” is expressly meant to include any sport that may be implemented as a “fantasy sport.” While the football version of “fantasy football” is used in many instances throughout this description to demonstrate many novel features and elements of the invention, the applicant does not limit such novel features and elements to only the football version. Such features, aspects and elements may be implemented and applied to any version or embodiment of the invention with respect to any sport, such as, for example, fantasy basketball, hockey, soccer, cricket, baseball, etc.

In standard fantasy sports games or leagues, teams of players are often, but not always, drafted for the entire season of the sport upon which the fantasy version is based (subject to cutting or dropping of players, trading, etc.). In leagues that allow or are based on “daily” or “weekly” drafts, teams of players are obviously drafted more frequently. However, regardless of draft frequency, the drafts in all such “daily” or “weekly” type leagues still permit participants to draft players for their teams indiscriminately—based on draft strategies, preferences, or other factors. That is, the only limitation on participants during the draft process is whether a desired player has already been drafted by another participant (and, thus, no longer available to draft). A novel feature of an embodiment of the invention is that one participant—through a “lead” pick—significantly limits an opposing participant's next draft selection by making that selection a “forced” pick (as discussed in greater detail, below). As such, draft strategy is more than just strategy, it is an integral part of the overall game.

The present invention introduces key distinctions from the existing fantasy platform that distinguishes it from the latter in important ways. These distinctions include, but are not necessarily limited to, the following:
The elimination or substantial reduction of a pre-season draft.
A roster selection process that occurs weekly (in football), daily or over several days in the other sports.
The removal of all or most roster continuity with fresh new “drafts”/roster selections each game (either weekly, daily or over several days depending on the sport).
The creation of “linked matchup positions” that guarantee head-to-head matchups at every fantasy position in every fantasy game. Pre-determined player positions are matched up for purposes of roster selection and game mechanics (e.g., offensive and corresponding defensive positions in football games, identical positions in basketball, typically offense vs. defense positions in soccer and hockey). Because of the pre-determined player positions, participants of the invention fantasy game are not always free to choose or draft any player at any position, based simply on draft strategy or personal preference. Rather, based on an opponent's “lead pick” or selection (also referred to herein as the “smash pick” selection), an opponent participant must select or draft a corresponding, pre-determined (usually by position) opposing player in a responding “forced pick” or selection.
In accordance with the foregoing, the creation of a “lead pick” by a participant, also called a “smash pick,” is pre-matched with a “forced pick” by the other participant during the roster selection or draft process. Each player's fresh roster consists of a pre-determined number of lead picks and an equal number of forced picks. As such, the draft is not only a critical factor of the game—as all draft selections are important in all fantasy sports—but with the present invention, the draft is an integral part of the game itself.
The creation of a mobile gaming platform, including a smartphone or mobile device application for development of a social gaming network. The application and website may comprise various “push” technologies (well known in the art for disseminating data over the Internet and global communications networks, including wireless and mobile networks) As such, two or more participants opposing each other are provided the opportunity to vary game play by offering “one-off” matches, similar to that employed by mobile “apps” for chess, digital Scrabble, Words With Friends, etc., that are not dependent on a fantasy league's ongoing schedule of games, since rosters are refreshed weekly, daily or over several days, depending on the specific sports organization's schedule. As such, when a participant of the invention game makes a draft selection—whether a lead pick or a forced pick—the opponent participant receives notification thereof on his or her computer or mobile device, using technologies commonly known by and understood in the art, and the opponent participant is then free to make his or her next selection in the draft process. This process continues until the draft is completed between the two players (while a league may be comprised of many individuals, say, perhaps 12 teams, each week teams are paired to play each other according to the league's schedule and each team playing in a game must complete the draft prior to the start of the actual games upon which the fantasy sport is based for that day, week, etc.). This feature highlights the asynchronous nature of the invention game—not all participants are “present”—whether physically or remotely via the Internet or other telecommunications networks—simultaneously to participate in a draft, and each draft between opposing participants proceeds independently at its own respective pace until concluded.

### BRIEF DESCRIPTION OF THE DRAWINGS

FIG. 1 depicts a screen shot of an online fantasy football platform operated by CBSSports.com, showing the final score of a game between two fantasy teams in a traditional head-to-head fantasy football league.

FIG. 2 is a series of depictions of a sample scoring system for a football based embodiment of the invention. FIG. 2A is a sample scoring system for the offensive position of Quarterback (QB); FIG. 2B is a sample scoring system for the offensive position of Running Back (RB); FIG. 2C is a sample scoring system for the offensive positions of Wide Receiver (WR), Tight End (TE) and Offense Flex (OFLX); FIG. 2D is a sample scoring system for the Offensive Line (OL); and FIG. 2E is a sample scoring system for the offensive position of Kicker (K). FIG. 2F is a sample scoring system for the defensive position of Safety (S); FIG. 2G is a sample scoring system for the defensive position of Corner Back (CB); FIG. 2H is a sample scoring system for the defensive position of Linebacker (LB); FIG. 2I is a sample scoring system for the Defensive Line (DL); and FIG. 2J is a sample scoring system for both offensive and defensive Special Teams (ST).

FIG. 3 depicts draft results and game results of an actual fantasy game played with the present invention between two players using only NFL Super Bowl 46 (Feb. 5, 2012) players and results.

FIG. 4 depicts a screen shot of an online fantasy football platform operated by CBSSports.com, showing the final score of the championship game between two fantasy teams in a traditional head-to-head fantasy football league from the final weekend of the NFL's 2011 season.

FIG. 5 depicts an exemplary linked position model for a football embodiment of the invention (Fantasy Football Game 500) that is based on the NFL and that utilizes a fourteen (14) player roster format comprising seven (7) offensive and seven (7) defensive players/positions for each opposing team.

FIG. 6 depicts an exemplary linked position model for a basketball based embodiment of the invention (Fantasy Basketball Game 600) that utilizes an eight (8) player roster format comprising eight (8) players/positions.

FIG. 7 depicts an exemplary linked position model for a hockey based embodiment of the invention (Fantasy Hockey Game 700) that utilizes an eight (8) player roster format comprising four (4) offensive and four (4) defensive players/positions for each opposing team.

FIG. 8 depicts an exemplary linked position model for a soccer based embodiment of the invention (Fantasy Soccer Game 800) that utilizes an eight (8) player roster format comprising four (4) offensive and four (4) defensive players/positions for each opposing team.

FIG. 9 depicts an exemplary linked position model for a baseball embodiment of the invention based on Major League Baseball (Fantasy Baseball Game 900) that utilizes an eighteen (18) player roster format comprising nine (9) pitcher and nine (9) batter players/positions for each opposing team.

### DETAILED DESCRIPTION

A more detailed description of the invention now follows.

The invention that is the subject of this application is an interactive fantasy football game employing a turn-based, asynchronous model that may be played between two (2) or more participants. As used herein, a “participant” or “user” of the game may be an individual (real person) or a “bot” (software program), or any combination thereof, and the game may be played using electronic mobile devices (such as cell phones, smart phones, pads, etc.), computers, laptops and any other electronic device capable of communicating with any other electronic device (currently existing or as may come into existence in the future) via the Internet or any other wired or wireless communications network system using well-established protocols generally known to those in the industry, currently existing or as may be established in the future. A novel feature of the invention, among others, is its turn-based, asynchronous game model. Standard “fantasy” based games, such as, but not including, fantasy football, often require that the draft portion be conducted as a single event at a predetermined time (e.g., Saturday, August 28 at 2:00 PM at Joe Smith's house) with all league participants present—either physically or via network connections—in order to conduct an expeditious and orderly draft of players. In addition, the game is not just the fantasy version of the reality games upon which it is based, but the game also comprises the “drafting” mechanism or portion, as described further herein.

While various embodiments of the invention may permit more than two (2) participants to play each other in a game, generally, the game is played only between two (2) participants to maximize the “linked” player aspect of the invention, the pre-determined lead or smash pick and the corresponding forced pick feature, discussed in greater detail, within.

Significantly, while the term “fantasy football” is used throughout this description to demonstrate a particular embodiment of the invention that is based on the game of football, in general, and the NFL, in particular, that term is expressly intended not to be limited only to the fantasy version of football. Rather, “fantasy football” is expressly meant to include any sport that may be implemented as a “fantasy sport.” Indeed, the game may be played using any other real-life sport in which two teams, each featuring two (2) or more players at a time, play each other, e.g., football, basketball, baseball, hockey, etc. While the football version of “fantasy football” is used in many instances throughout this description to demonstrate many novel features and elements of the invention (fantasy football, perhaps the most popular of all such fantasy games, has been in existence for decades and may be played in a number of ways using various scoring techniques, as previously discussed), the applicant does not limit such novel features and elements to only the football version. Such features, aspects and elements may be implemented and applied to any version or embodiment of the invention with respect to any sport, such as, for example, fantasy basketball, hockey, soccer, cricket, baseball, etc.

In standard fantasy sports games or leagues, teams of players are often, but not always, drafted for the entire season of the sport upon which the fantasy version is based (subject to cutting or dropping of players, trading, etc.). In leagues that allow or are based on “daily” or “weekly” drafts, teams of players are obviously drafted more frequently. However, regardless of draft frequency, the drafts in all such “daily” or “weekly” type leagues still permit participants to draft players for their teams indiscriminately—based on draft strategies, preferences, or other factors. That is, the only limitation on participants during the draft process is whether a desired player has already been drafted by another participant (and, thus, no longer available to draft). A novel feature of an embodiment of the invention is that one participant—through a “lead” pick—significantly limits an opposing participant's next draft selection by making that selection a “forced” pick (as discussed in greater detail, below). As such, draft strategy is more than just strategy, it is an integral part of the overall game.

The common fantasy platform, as embodied in the prior art, is the assembly by fantasy game participants—by way of a draft or player selection process—of a finite lineup or roster of professional and/or amateur athletes to create a unique fantasy “team.” Game participants and their teams are then paired off to play each other, according to the league's schedule, whereby their roster of athletes amass points based on pre-determined rules relating to the athletes' performance in a regularly scheduled game within their actual sports organization or league. The fantasy team that assembles a roster of players who amass the most points from their actual sports organization game is declared the winner of that fantasy contest or game. This is a typical “head-to-head” fantasy sport format.

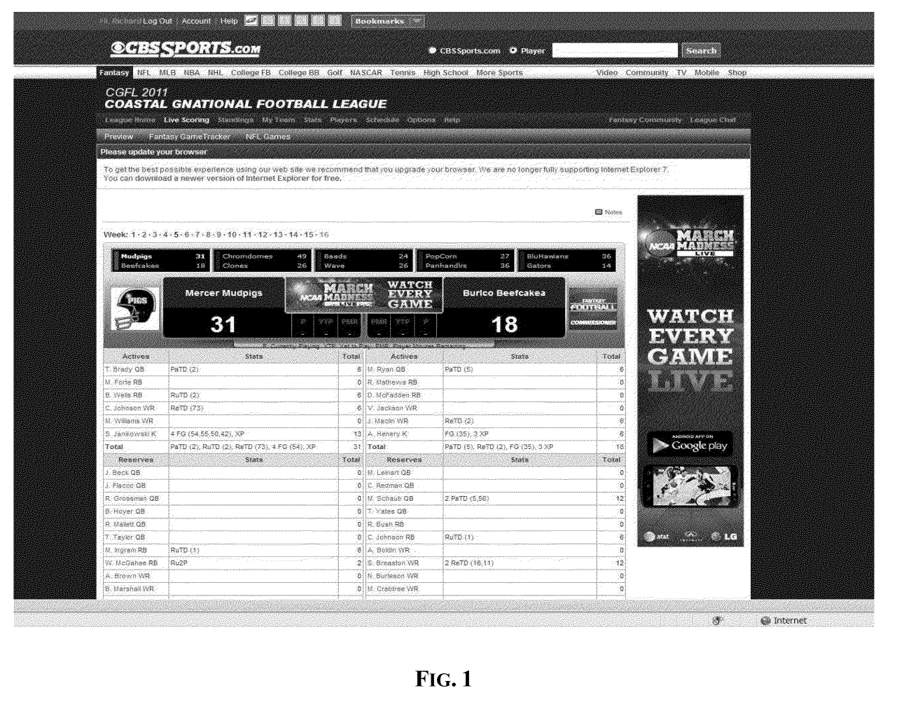

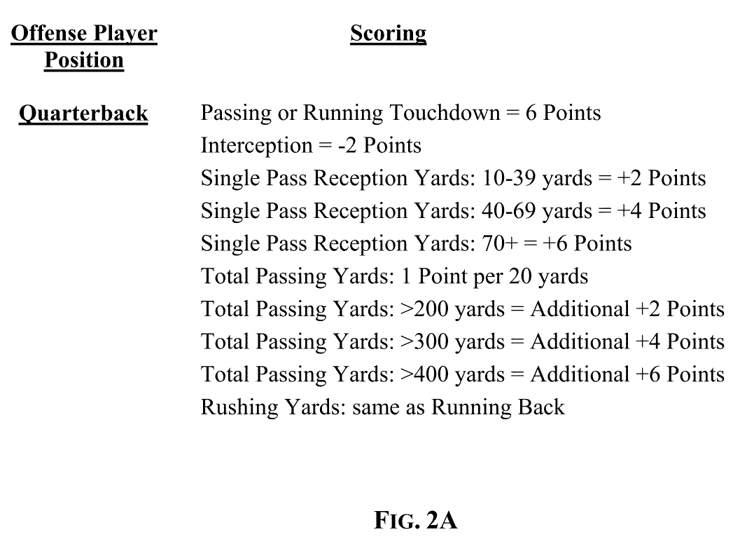

Referring to such common “head-to-head” prior art fantasy football, one such example may be the Coastal Gnational Football League (the “CGFL”), a private fantasy football league comprising ten (10) individual teams that are each “managed” by an individual playing the game. In this example, the CGFL is operated and administered online by the league's commissioner through an Internet based fantasy sports platform at CBS Sports Online at CBSSports.com. The CGFL teams are each run or managed by individual members of the League, who select or draft their respective team's players from the NFL. The draft is held prior to the opening weekend of the NFL's season. Each week, each team in the CGFL plays another team in the league and, through CBS Sports.com, each team's owner or manager submits a starting lineup in accordance with the CGFL league rules. Since there are ten (10) teams in the CGFL league, there are five (5) individual matchups or games each week and each week each team plays another team. Given the length of the NFL season, some teams will play each other twice. The points scored by each team in the CGFL are directly based on the points, if any, scored by the corresponding actual NFL players comprising the CGFL team's starting lineup, in accordance with the CGFL's scoring system. In each of the five (5) weekly contests in the CGFL (each contest featuring two teams playing each other), the team with the greater number of points is the winner of that contest. FIG. 1 is a screen shot of CBSSports.com of week 5 scoring (2011 season) of the CGFL, with the details of the Mudpigs v. Beefcakes game appearing (the Mudpigs and the Beefcakes being the names of the two competing fantasy teams in the particular CGFL contest shown). The scoring of the other games of that week in the CFL appear at the top and the details may be accessed by clicking on the links of the respective game at the top of the page.

The present invention, however, comprises a unique variation of fantasy sports gaming. In an embodiment, the invention comprises a novel roster selection or draft process that eliminates or drastically reduces the need for a pre-season draft. The invention combines a new roster selection process whereby participants on a daily to weekly basis—depending on the sport and individual league rules—choose or draft their rosters through a series of picks and counter-picks by their opponent and vice-versa based on pre-determined “linked” positions. These picks and counter-picks are “linked” based on on-field positions of the respective sport (e.g., a running back is linked with an opposing linebacker in football; a point guard is lined with an opposing point guard in basketball; a forward is linked with an opposing fullback in soccer, etc.). Each initial or “lead” pick by a participant is immediately thereafter followed by a “forced” pick by the opponent participant, who thereafter executes a lead pick, to be immediately followed thereafter by a forced pick by the first participant (as used in this sentence, “immediate” doesn't refer to length of time, but rather, it means without any intervening action in the draft process.

This process continues back and forth until the rosters of both participants are complete. As a further example, in football, running backs are linked with the opposing team's linebackers, so a fantasy participant who uses a lead or smash pick to select a running back thereby effectively “forces” his opponent to draft or select a linebacker whose team plays against that same running back in the upcoming football game, whether it be a game from the NFL, CFL, or NCAA game. As such, all forced picks are based on limited discretion—a forced pick must select a pre-determined position player from the actual sports team that is opposing the team of the player who is the subject of the immediately preceding lead or smash pick. Participants and their teams then amass points based on the performance of the athletes on their roster in their regularly scheduled league game and according to pre-determined rules of the particular league employing the invention game.

The present invention introduces key distinctions from existing fantasy platforms that distinguish it from the latter in important ways. These distinctions include, but are not necessarily limited to, the following.
The elimination or substantial reduction of a pre-season draft.
A roster selection process that occurs weekly (in football), daily or over several days in the other sports.
The removal of all or most roster continuity with fresh new “drafts”/roster selections each game (either weekly, daily or over several days depending on the sport).
The creation of “linked matchup positions” that guarantee head-to-head matchups at every fantasy position in every fantasy game. Pre-determined player positions are matched up for purposes of roster selection and game mechanics (e.g., offensive and corresponding defensive positions in football games, identical positions in basketball, typically offense vs. defense positions in soccer and hockey). Because of the pre-determined player positions, participants of the invention fantasy game are not always free to choose or draft any player at any position, based simply on draft strategy or personal preference. Rather, based on an opponent's “lead pick” or selection (also referred to herein as the “smash pick” selection), an opponent participant must select or draft a corresponding, pre-determined (usually by position) opposing player in a responding “forced pick” or selection.
In accordance with the foregoing, the creation of a “lead pick” by a participant, also called a “smash pick,” is pre-matched with a “forced pick” by the other participant during the roster selection or draft process. Each player's fresh roster consists of a pre-determined number of lead picks and an equal number of forced picks. As such, the draft is not only a critical factor of the game—as all draft selections are important in all fantasy sports—but with the present invention, the draft is an integral part of the game itself.
The creation of a mobile gaming platform, including a smartphone or mobile device application or “app” for development of a social gaming network. The application and website may comprise various “push” technologies (well known in the art for disseminating data over the Internet and global communications networks, including wireless and mobile networks) As such, two or more participants opposing each other are provided the opportunity to vary game play by offering “one-off” matches, similar to that employed by mobile “apps” for chess, digital Scrabble, Words With Friends, etc., that are not dependent on a fantasy league's ongoing schedule of games, since rosters are refreshed weekly, daily or over several days, depending on the specific sports organization's schedule. As such, when a participant of the invention game makes a draft selection—whether a lead pick or a forced pick—the opponent participant receives notification thereof on his or her computer or mobile device, using technologies commonly known by and understood in the art, and the opponent participant is then free to make his or her next selection in the draft process. This process continues until the draft is completed between the two players (while a league may be comprised of many individuals, say, perhaps 12 teams, each week teams are paired to play each other according to the league's schedule and each team playing in a game must complete the draft prior to the start of the actual games upon which the fantasy sport is based for that day, week, etc.). This feature highlights the asynchronous nature of the invention game—not all participants are “present”—whether physically or remotely via the Internet or other telecommunications networks—simultaneously to participate in a draft, and each draft between opposing participants proceeds independently at its own respective pace until concluded.

While the pre-season draft is essentially eliminated in an embodiment of the invention, in another embodiment, the game format involves a “franchise player” draft, whereby participants have the option to draft a specific player or players at a specific position and be awarded that player in each pre-determined selection process and whereby said participant's opponent will have the corresponding “forced pick.”

In an embodiment of the invention, the lineup/roster selection process is based on pre-determined games and pre-determined offense vs. defense positional matchups in football, identical positions in basketball, and typically offense vs. defense positions in soccer and hockey. For example, and as detailed further within, in the professional football version (NFL, CFL, etc.) embodiment of the invention, a participant selects a lineup/roster each week from available corresponding organization games. For example, in an NFL-based format of the invention, league and/or individual participants can determine if they will select or draft lineups/rosters from a limited schedule (e.g., 5 games chosen from the weekly NFL schedule) or from the full NFL weekly schedule. The invention allows such flexibility and may be adapted according to league preferences.

In another embodiment, for the amateur football version of the invention, the lineups/roster are chosen each week from variable pre-selected NCAA games. Variations and stratifications may include, but are not necessarily limited to, NCAA conferences (e.g., SEC or ACC only), Top 25 ranked teams, geographies (e.g., national or regional only), alma mater relevance, division levels (e.g., FBS or BCS only), players' choice, random selection, etc. Leagues and participants of the invention may determine the number of games from which to choose.

In yet another embodiment of the football version of the invention, lineups/rosters are possessed for one week at a time, except in “franchise” leagues whereby one or two players may be drafted pre-season. Soccer, hockey and basketball embodiments or versions will have equal or shorter time intervals to accommodate their respective organization game schedules. In whichever sport, each subsequent week (or other time interval as appropriate) presents a clean slate and new opportunity for roster selection versus your new opponent based on the contest schedule, except as mentioned, in “franchise” league embodiments of the invention.

In various other embodiments of the invention, leagues and individuals will determine precise scheduling format, including the number of professional sports organization contests and any specific variations. Once determined, “game play” commences with an electronic coin-toss or other random selection process to determine which invention user picks first. As used herein the term “game play” is intended to mean the process followed by two opposing participants to play the invention game and interact with each other throughout the process, including adherence to game rules of a particular embodiment, the draft process, the pre-determined linkage of players (linked positions), the “lead” and “forced” pick feature, the selection of a full roster by each participant and the actual scoring system and rules of a particular league.

Referring now to an NFL football based embodiment of the invention (which may be similarly adapted with or to any sport, as demonstrated herein), each participant's weekly roster must comprise positions on both offense and defense, each of which is linked to a pre-determined opposing position on defense and offense competing in the same organization (NFL, CFL, or NCAA) game as the aforementioned roster position. For example, if a league uses an eighteen (18) player roster model, the positions of each participant's roster will comprise nine (9) offensive and nine (9) defensive players. Once the selection process is complete, each participant's roster or team will comprise eighteen (18) total players—nine (9) offense players and nine (9) defense players—and each player will be linked to the opposing team's player based on their exact position (e.g., Quarterback (QB) (offense) is linked to Safety (S) (defense); Linebacker (LB) (defense) is linked to Running Back (RB) (offense), etc.) within the same organization, e.g., the NFL, CFL, NCAA, etc. football game.

In the football embodiment of the invention, the position links may be as follows:
Quarterback (QB) vs. Safety (S) (i.e., Quarterback, an offensive player position, are always linked to Safety, a defensive player position, in this particular embodiment. The “vs.” designation is to demonstrate the link between the two positions).
Running Back 1 (RB1) vs. Linebacker 1 (LB1)
Running Back 2 (RB2) vs. Linebacker 2 (LB2)
Tight End (TE) vs. Linebacker 3 or Safety 2 (LB3 or S2)
Wide Receiver 1 (WR1) vs. Cornerback 1(CB1)
Wide Receiver 2 (WR2) vs. Cornerback 2 (CB2)
Offensive Flex position (OFLX) vs. Defensive Flex position (DFLX) (Note: OFLX can be Running Back 3 (RB3) or Tight End 2 (TE2) vs. DFLX, which may be Linebacker 4 (LB4) (or Linebacker 3 (LB3) if there is a Safety 2 (S2)) or OFLX may be Wide Receiver 3 (WR3) vs. DFLX Cornerback 3 (CB3))
Offensive Line (OL) vs. Team Defense (D)
Kicker (K) vs. Special Teams (ST)

Based on the foregoing, by way of example only, if Participant 1 selects Quarterback Joe Flacco of the Baltimore Ravens (an NFL franchise team) as his first lead (smash) pick, then Participant 1's opponent, Participant 2, must select (i.e., his corresponding or linked “forced” pick) a Safety from the NFL team playing against the Baltimore Ravens that particular week for which this draft is intended. If the Baltimore Ravens are playing the New York Giants, another NFL franchise team, that week, Participant 2's forced pick is restricted to only those Safeties on the current New York Giants roster. The “forced” pick is always limited or restricted as such. However, a lead pick is not restricted to an offensive player; in this example, Participant 1 could have selected a defensive player, such as a New York Giants Safety, in which case Participant 2's forced pick would have to have been Joe Flacco, the Baltimore Raven's QB playing opposite the New York Giant's Safety.

After Participant 2 completes his forced pick (a New York Giants Safety), Participant 2 makes a lead or smash draft pick selection of his choice—either an offensive or defensive player. If Participant 2 selects as his lead second round pick Running Back (RB) Adrian Petersen of the Minnesota Vikings, and if the Vikings are playing the Chicago Bears that particular week, then Participant 1's forced second round pick must be a Linebacker from the Chicago Bears. The process continues in such fashion until the rosters of Participant 1 and Participant 2's respective teams are filled.

Under this particular embodiment and version of an embodiment of the invention, in the football model above, once the roster selection process is complete both Participant 1 and Participant 2 will each have the following 9 Offensive and 9 Defensive positions on their respective teams:

Offensive Players:

1. Quarterback (QB)

2. Running Back 1 (RB1)

3. Running Back 2 (RB2)

4. Tight End (TE)

5. Wide Receiver 1 (WR1)

6. Wide Receiver 2 (WR2)

7. Offensive Flex Player (OFLX)—additional RB, TE or WR

8. Team Offensive Line (OL)

9. Kicker (K)

Defensive Players:

1. Safety (S)

2. Linebacker 1 (LB1)

3. Linebacker 2 (LB2)

4. Linebacker 3 (LB3) or Safety 2 (S2)

5. Cornerback 1 (CB1)

6. Cornerback 2 (CB2)

7. Defensive Flex Player (DFLX)—additional LB, S, or CB

8. Team Defense (D)

9. Team Special Teams (ST)

In this particular model or example of a football embodiment of the invention, each of Participant 1's Offensive positions (#s 1-9) is linked to each of Player 2's Defensive positions (#s 10-18) per the numerical order above. Each linked position (e.g., QB and S) must come from the same NFL game whereby Participant 1's QB is playing against Participant 2's S in the actual contest and vice versa for all matchups.

In the football model, each of Participant 1's Offensive positions (#s 1-9) is linked to each of Player 2's Defensive positions (#s 10-18) per the numerical order above. Each linked position (e.g., QB and S) must come from the same NFL game whereby Participant 1's QB is playing against Participant 2's S in the actual contest and vice versa for all matchups.

Using an NFL invention model with league play, the following provides a step-by-step example of creation and play process.
Step 1 Individual league creation and rules established (in this exemplary embodiment, a five weekly NFL game format with 18 roster positions per team is demonstrated) and team schedules set.
Step 2 An electronic coin toss determines which of the two Participants (identified here as Participant 1 and Participant 2) will pick first.
Step 3 Participant 1 wins the toss and chooses first.
Step 4 Round by round roster selection conducted as follows from Tuesday through Saturday of given week (each pick triggers “push” notification to opponent via e-mail, text, or application message alert through the Internet or other communications network system using established protocols currently existing or as may be established in the future) (or any variation of the following):

Round 1: Player 1 Smash Pick/Player 2 Forced Pick

Round 2: Player 2 Smash Pick/Player 1 Forced Pick

Round 3: Player 1 Smash Pick/Player 2 Forced Pick

Round 4: Player 2 Smash Pick/Player 1 Forced Pick

Round 5: Player 1 Smash Pick/Player 2 Forced Pick

Round 6: Player 2 Smash Pick/Player 1 Forced Pick

Round 7: Player 1 Smash Pick/Player 2 Forced Pick

Round 8: Player 2 Smash Pick/Player 1 Forced Pick

Round 9: Player 1 Smash Pick/Player 2 Forced Pick

Round 10: Player 2 Smash Pick/Player 1 Forced Pick

Round 11: Player 1 Smash Pick/Player 2 Forced Pick

Round 12: Player 2 Smash Pick/Player 1 Forced Pick

Round 13: Player 1 Smash Pick/Player 2 Forced Pick

Round 14: Player 2 Smash Pick/Player 1 Forced Pick

Round 15: Player 1 Smash Pick/Player 2 Forced Pick

Round 16: Player 2 Smash Pick/Player 1 Forced Pick

Round 17: Player 1 Smash Pick/Player 2 Forced Pick

Round 18: Player 2 Smash Pick/Player 1 Forced Pick
Step 5 Auto Roster adjustments based on Injury Report (next player on depth chart auto selected for Out or Doubtful players) on Saturday
Step 6—Kickoff!

While various embodiments of the present invention may be played with players/participants physically present in one location, and drafting and scoring conducted in manual fashion, the invention's draft and scoring aspects are preferably conveyed, transmitted and communicated through the Internet or other communications network system(s) using well known and established protocols, currently existing or as may be established in the future, including “push” technologies, java scripts, or any other technology that may be used to implement the game to and through electronic devices. An embodiment of the invention comprises the use of mobile device applications or “apps” so that drafts and game scoring and results may be executed between the respective players without the use of cumbersome Internet browsers, such as Microsoft Internet Explorer, Apple Safari, Google Chrome, Mozilla FireFox, etc., although players may use Internet browsers to access a main website for such purposes, using a login name and password. As such, drafts may be executed and game scoring monitored via home or work computers or mobile devices of any sort (iPhone, Android phones, Windows based devices, etc.) and draft picks and game scores may be updated in real time through the use of java or other technologies involving a data “push” process so that a player using an Internet browser—whether on a standard workstation computer or other device—receives data (e.g., an opponent's draft pick or game scores, by NFL player) in real time without taking any action, such as refreshing the browser, etc. The fantasy game of the present invention is not technology specific and may be implemented via the Internet, global network communications systems and platforms, including wireless communications technologies, and mobile technologies and platforms.

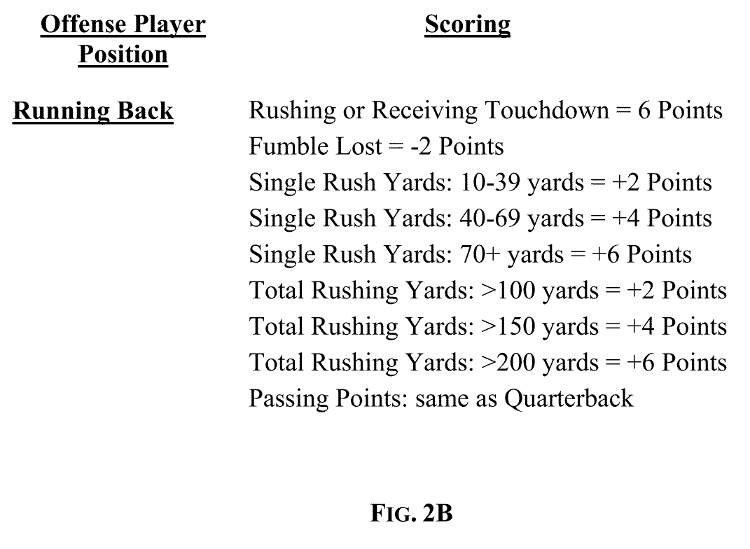

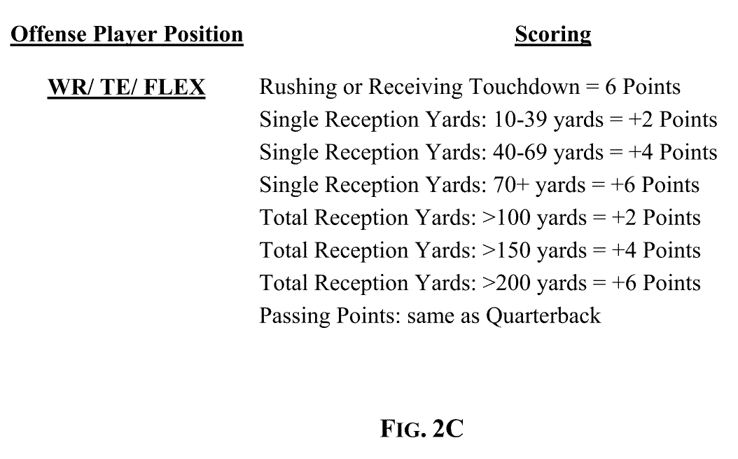

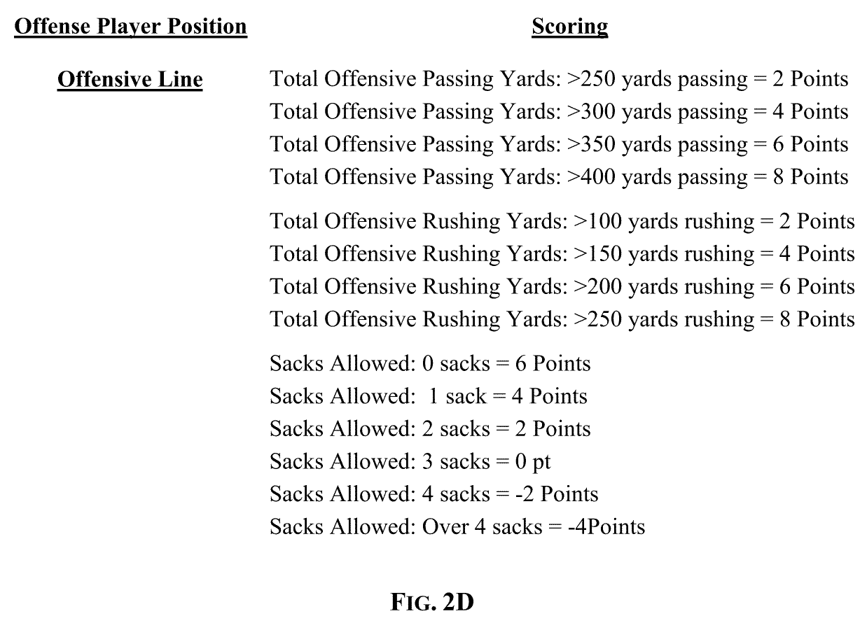

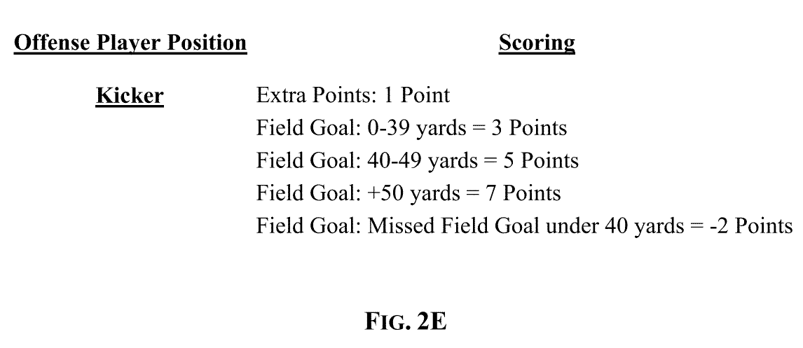

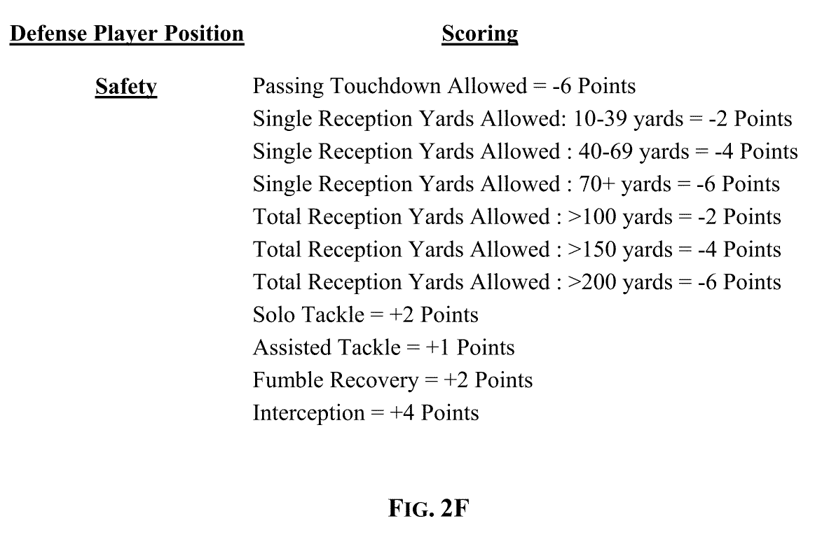

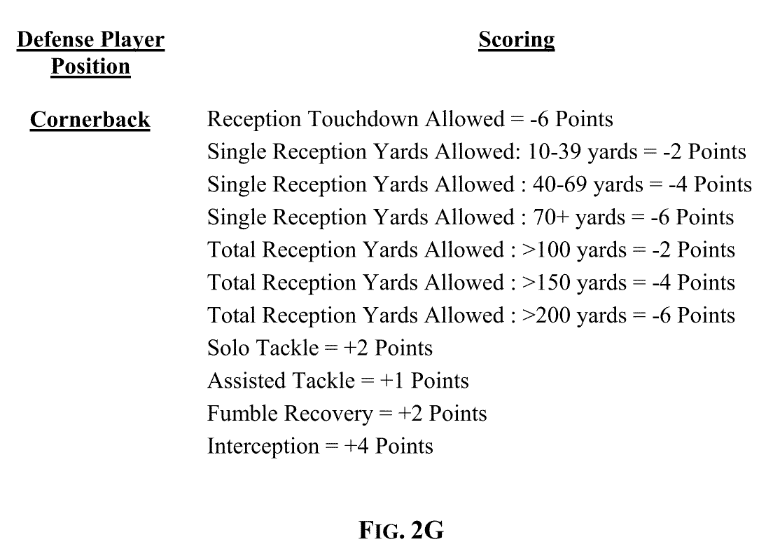

FIG. 2 is a series of depictions of a sample scoring system for a football based embodiment of the invention. Scoring may be simple or it may be complex—each league may establish its own rules as to how points are compiled based on actual player performance, in this case, players in the NFL. FIG. 2A is a sample scoring system for the offensive position of Quarterback (QB); FIG. 2B is a sample scoring system for the offensive position of Running Back (RB); FIG. 2C is a sample scoring system for the offensive positions of Wide Receiver (WR), Tight End (TE) and Offense Flex (OFLX); FIG. 2D is a sample scoring system for the Offensive Line (OL); and FIG. 2E is a sample scoring system for the offensive position of Kicker (K). FIG. 2F is a sample scoring system for the defensive position of Safety (S); FIG. 2G is a sample scoring system for the defensive position of Corner Back (CB); FIG. 2H is a sample scoring system for the defensive position of Linebacker (LB); FIG. 2I is a sample scoring system for the Defensive Line (DL); and FIG. 2J is a sample scoring system for both offensive and defensive Special Teams (ST).

FIG. 3 depicts draft results and game results of an actual fantasy game played with the present invention between two players using only NFL Super Bowl 46 (Feb. 5, 2012) players and results. An appealing feature of the present invention is that, unlike traditional fantasy football (or other fantasy sports), it may be played at anytime under any circumstances—including when there is only one “real life” game featuring only two (2) teams—such as the NFL's Super Bowl. Since traditional fantasy football requires the availability of ALL teams and players in the NFL, typically, a fantasy football league ends on the final date of the NFL's regular season, for after that weekend, the NFL is in extended playoff season and not all teams and players are involved. As such, a fantasy football league's “super bowl” or championship game is typically the final weekend of the NFL's regular season (or earlier, depending on a league's setup, schedule or rules). As an example, see the scoring of CGFL's championship game played on the final weekend of the NFL's 2011 season, attached as FIG. 4. In this case, the Panhandlers beat the Beefcakes in a score of 45 to 20 in the CGFL's Championship Game for the 2011 season.

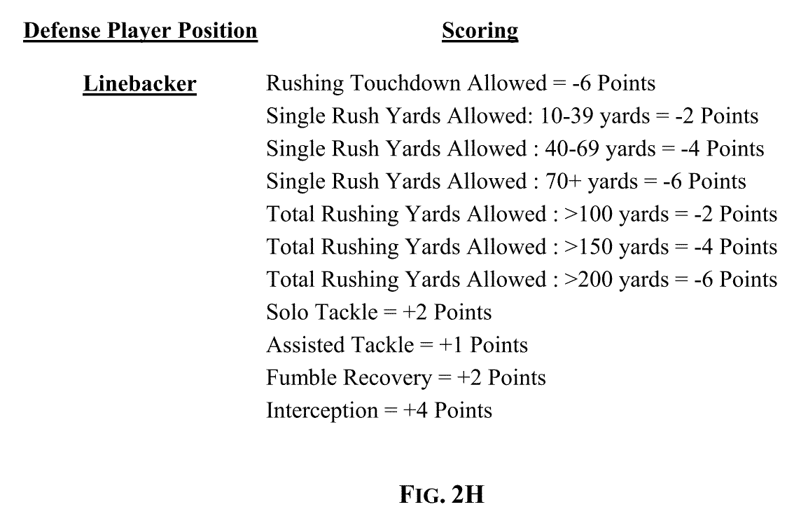

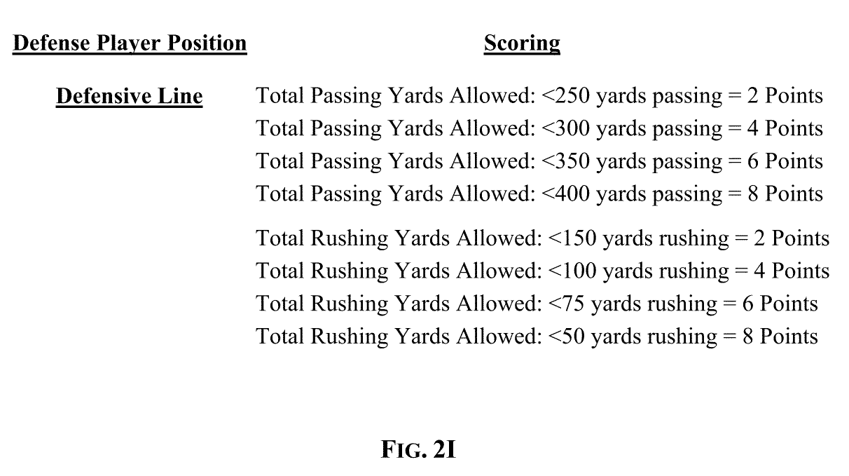

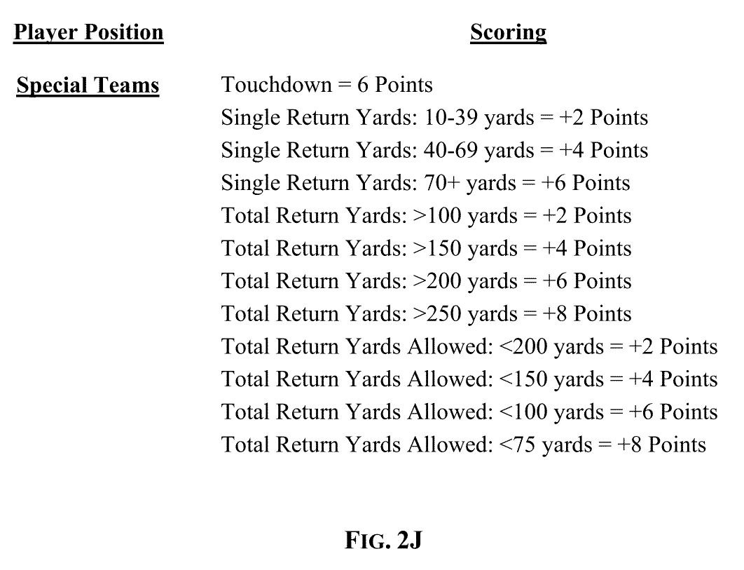

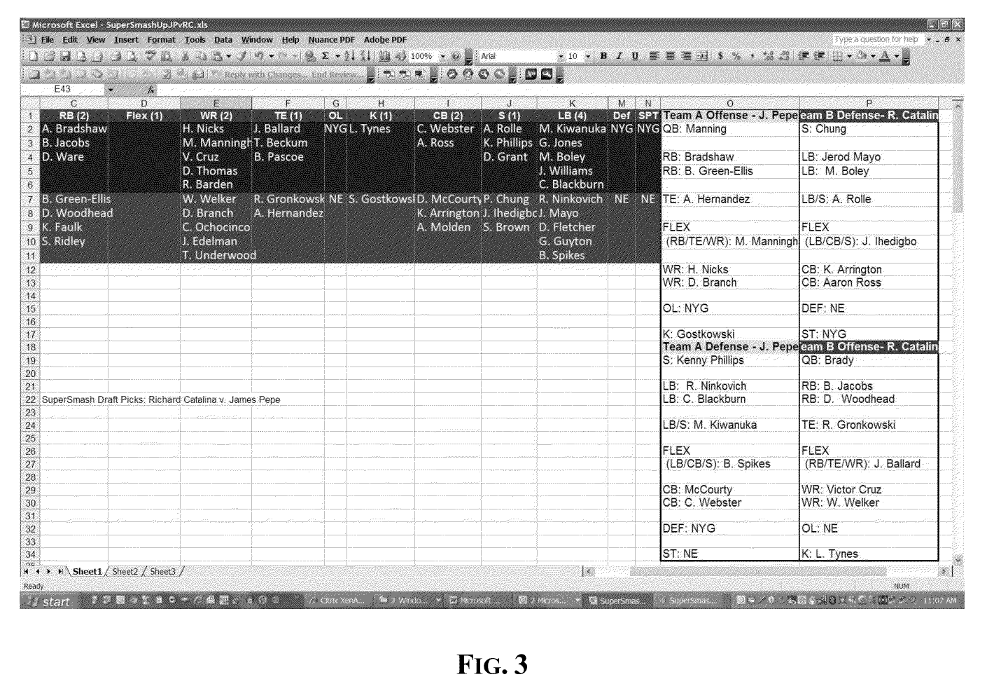

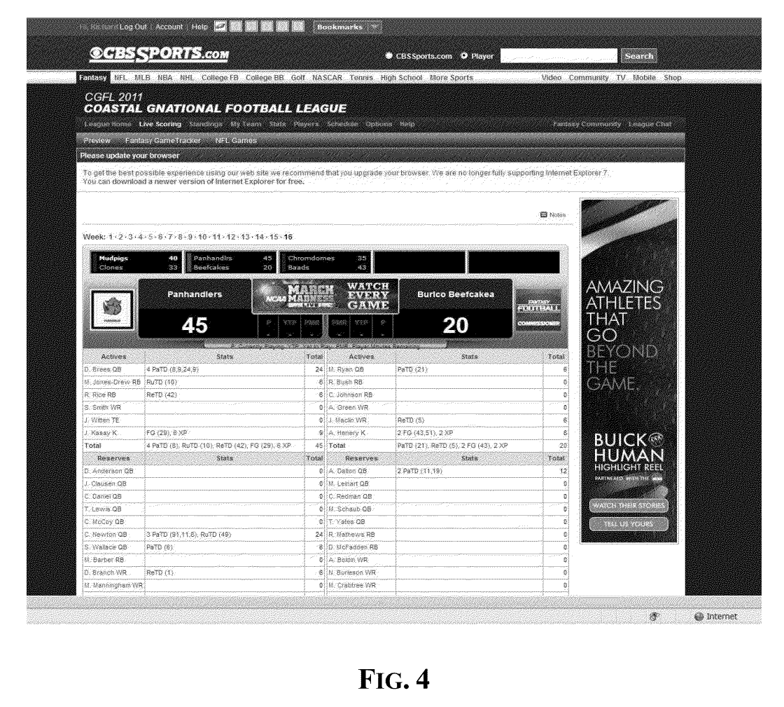

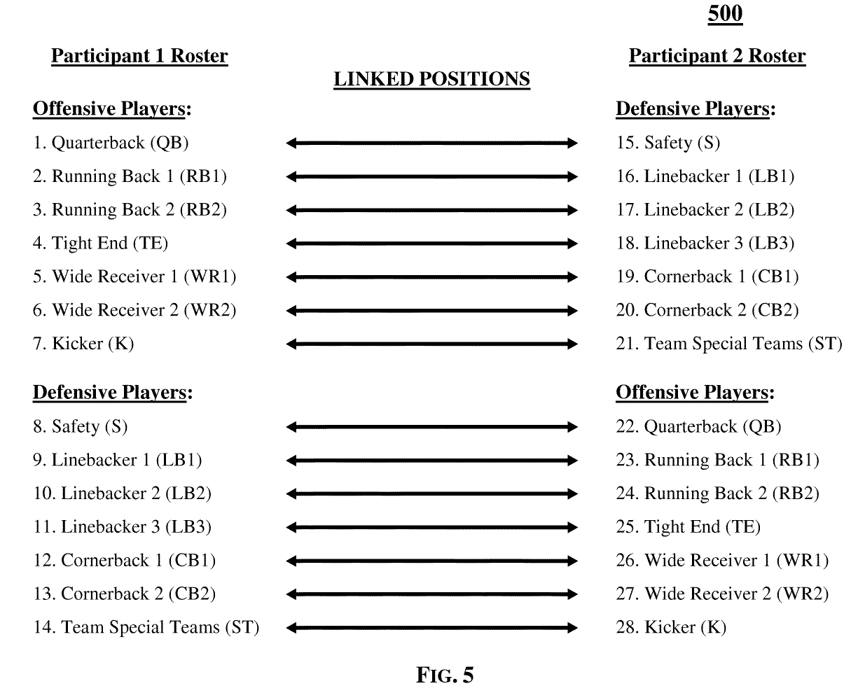

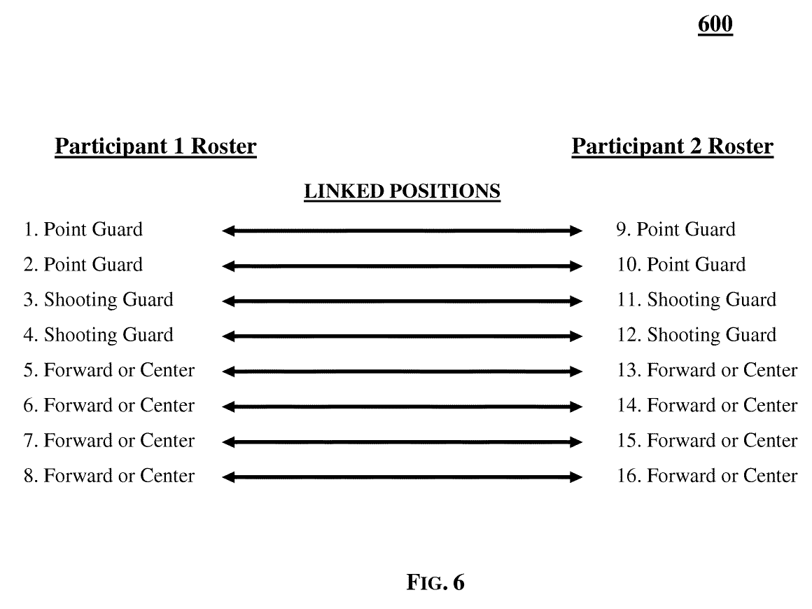

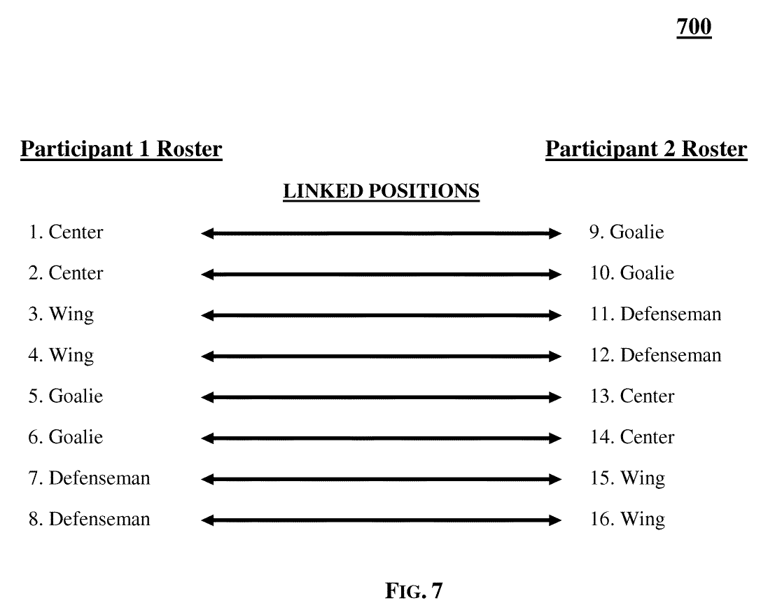

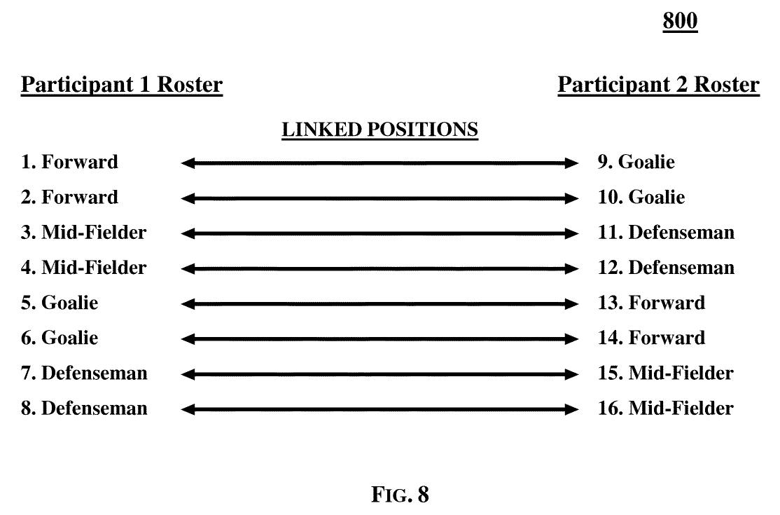

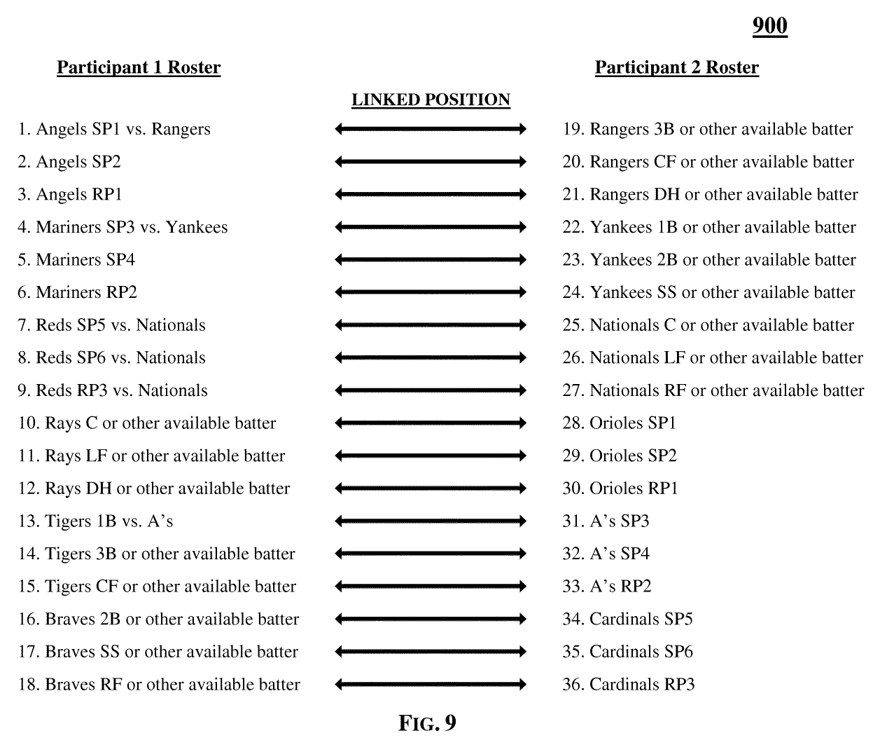

FIG. 5, FIG. 6, FIG. 7, FIG. 8 and FIG. 9 respectively depict various exemplary linked position models for a football embodiment of the invention (Fantasy Football Game 500), a basketball based embodiment of the invention (Fantasy Basketball Game 600), a hockey based embodiment of the invention (Fantasy Hockey Game 700), a soccer based embodiment of the invention (Fantasy Soccer Game 800), and a baseball embodiment of the invention based on Major League Baseball (Fantasy Baseball Game 900) and are all discussed in greater detail with respect to the following Examples.

### EXAMPLES

The following are examples of various embodiments of the invention as applied to different sporting games, in this case, football (Example 1), basketball (Example 2), hockey (Example 3), soccer (Example 4), baseball (Example 5), cricket (Example 6) and tournament play (any sport) (Example 7).

### Example 1

### Football (FIG. 5)

In this Football example (also depicted as game 500 in FIG. 5), each weekly roster must comprise positions on both offense and defense, each of which is linked to a pre-determined opposing position on defense and offense competing in the same organization (NFL, CFL, or NCAA) game as the aforementioned roster position. Play can incorporate any number of roster requirements, however, for demonstration purposes, this example uses a 14 player roster model comprising seven (7) offensive and seven (7) defensive players/positions. Once the selection process is complete, each Participant will have fourteen (14) players—seven (7) on offense and seven (7) on defense—and each player will be linked to the opposing teams player based on their exact position (e.g., QB vs. Safety, LB vs. RB, etc.) within the same organization (NFL, CFL, NCAA) game. The standard linked positions are as follows, but can include any variety therein:
   QB vs. S
   RB1 vs. LB1
   RB2 vs. LB2
   TE vs. LB3
   WR1 vs. CB1
   WR2 vs. CB2
   K vs. ST
In this Football Example, once the roster selection process of above is complete, both Participant 1 and Participant 2 must have the following 7 Offensive and 7 Defensive positions:

| | LINKED | |
|---|---|---|
| | POSI- | |
| Participant 1 Roster | TIONS | Participant 2 Roster |
| Offensive Players: | | Defensive Players: |
| 1. Quarterback (QB) | [symbol] | 15. Safety (S) |
| 2. Running Back 1 (RB1) | [symbol] | 16. Linebacker 1 (LB1) |
| 3. Running Back 2 (RB2) | [symbol] | 17. Linebacker 2 (LB2) |
| 4. Tight End (TE) | [symbol] | 18. Linebacker 3 (LB3) |
| 5. Wide Receiver 1 (WR1) | [symbol] | 19. Cornerback 1 (CB1) |
| 6. Wide Receiver 2 (WR2) | [symbol] | 20. Cornerback 2 (CB2) |
| 7. Kicker (K) | [symbol] | 21. Team Special Teams (ST) |
| Defensive Players: | | Offensive Players: |
| 8. Safety (S) | [symbol] | 22. Quarterback (QB) |
| 9. Linebacker 1 (LB1) | [symbol] | 23. Running Back 1 (RB1) |
| 10. Linebacker 2 (LB2) | [symbol] | 24. Running Back 2 (RB2) |
| 11. Linebacker 3 (LB3) | [symbol] | 25. Tight End (TE) |
| 12. Cornerback 1 (CB1) | [symbol] | 26. Wide Receiver 1 (WR1) |
| 13. Cornerback 2 (CB2) | [symbol] | 27. Wide Receiver 2 (WR2) |
| 14. Team Special Teams (ST) | [symbol] | 28. Kicker (K) |

In this Football Example, each of Participant 1's offensive positions (#s 1-7) is linked to each of Participant 2's defensive positions (#s 15-21) per the numerical order above and each of Participant 1's defensive positions (#s 8-14) is linked to each of Participant 2's offensive positions (#s 22-28). Each linked position (e.g., QB and S) must come from the same NFL game whereby Participant 1's QB is playing against Participant 2's S in the actual contest and vice versa for all matchups.
Using an NFL invention model with league play, the following provides a step-by-step example of creation and play process.
Step 1—Individual league creation and rules established (in this example, a five weekly NFL game format with 14 roster positions per team is demonstrated) and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly as follows for a defined time period (e.g., from Tuesday to Saturday of given week), each pick triggers “push” notification to opponent via e-mail, text, or application message alert through the
Internet or other communications network system using established protocols currently existing or as may be established in the future, or any variation of the following depending on professional sports league schedule:
   Round 1: Participant 1 Smash Pick/Participant 2 Forced Pick
   Round 2: Participant 2 Smash Pick/Participant 1 Forced Pick
   Round 3: Participant 1 Smash Pick/Participant 2 Forced Pick
   Round 4: Participant 2 Smash Pick/Participant 1 Forced Pick
   Round 5: Participant 1 Smash Pick/Participant 2 Forced Pick
   Round 6: Participant 2 Smash Pick/Participant 1 Forced Pick
   Round 7: Participant 1 Smash Pick/Participant 2 Forced Pick
   Round 8: Participant 2 Smash Pick/Participant 1 Forced Pick
   Round 9: Participant 1 Smash Pick/Participant 2 Forced Pick
   Round 10: Participant 2 Smash Pick/Participant 1 Forced Pick
   Round 11: Participant 1 Smash Pick/Participant 2 Forced Pick
   Round 12: Participant 2 Smash Pick/Participant 1 Forced Pick
   Round 13: Participant 1 Smash Pick/Participant 2 Forced Pick
Round 14: Participant 2 Smash Pick/Participant 1 Forced Pick
Step 5—Auto Roster adjustments based on Injury Report (next player on depth chart auto selected for Out or Doubtful players) on Saturday.
Step 6—Kickoff!

### Example 2

### Basketball (FIG. 6)

In this Basketball example (also depicted as Game 600 in FIG. 6), each weekly roster comprises positions on both offense and defense; however, since basketball's fluid game leads players to play both offense and defense at the same time while they are on the court, positions are linked to the pre-determined same position versus the competing actual basketball team in the same organization's (e.g., NBA or NCAA) game. Play can incorporate any number of roster requirements; however, for demonstration purposes, this example uses an eight (8) player roster model comprising eight (8) players/positions. Once the selection process is complete, each Participant will have eight (8) players and each player will be linked to the opposing teams player at the same or similar position based on pre-determined links (e.g., PG vs. PG, G v G, F vs. F, F vs. C, etc.) within the same organization (e.g., NBA or NCAA) game. The sample linked positions for an 8 player team are as follows, but can include any variety therein:
   PG1 vs. PG1
   PG2 vs. PG2
   SG1 vs. SG1
   SG2 vs. SG2
   ForCvs.ForC
   ForCvs.ForC
   ForCvs.ForC
   ForCvs.ForC
In the Basketball Example, once the roster selection process of above is complete, both Participant 1 and Participant 2 must have the following 8 positions:

| | LINKED | |
|---|---|---|
| | POSI- | |
| Participant 1 Roster | TIONS | Participant 2 Roster |
| 1. Point Guard | [symbol] | 9. Point Guard |
| 2. Point Guard | [symbol] | 10. Point Guard |
| 3. Shooting Guard | [symbol] | 11. Shooting Guard |
| 4. Shooting Guard | [symbol] | 12. Shooting Guard |
| 5. Forward or Center | [symbol] | 13. Forward or Center |
| 6. Forward or Center | [symbol] | 14. Forward or Center |
| 7. Forward or Center | [symbol] | 15. Forward or Center |
| 8. Forward or Center | [symbol] | 16. Forward or Center |

In this Basketball Example, each of Participant 1's positions (#s 1-8) is linked to each of Participant 2's positions (#s 9-16) per the numerical order above. Each linked position (e.g., PG and PG) must come from the same NBA (or NCAA) game whereby Participant 1's PG is playing against Participant 2's PG in the actual contest and vice versa for all matchups.
Using an NBA invention model with league play, the following provides a step-by-step example of creation and play process.
Step 1—Individual league creation and rules established (in this example, an eight weekly NBA game format with 8 roster positions per team is demonstrated) and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly as follows for a defined time period (e.g., from Tuesday to Saturday of given week), each pick triggers “push” notification to opponent via e-mail, text, or application message alert through the Internet or other communications network system using established protocols currently existing or as may be established in the future, or any variation of the following depending on professional sports league schedule:
   Round 1: Participant 1 Smash Pick/Participant 2 Forced Pick
   Round 2: Participant 2 Smash Pick/Participant 1 Forced Pick
   Round 3: Participant 1 Smash Pick/Participant 2 Forced Pick
   Round 4: Participant 2 Smash Pick/Participant 1 Forced Pick
   Round 5: Participant 1 Smash Pick/Participant 2 Forced Pick
   Round 6: Participant 2 Smash Pick/Participant 1 Forced Pick
   Round 7: Participant 1 Smash Pick/Participant 2 Forced Pick
   Round 8: Participant 2 Smash Pick/Participant 1 Forced Pick
Step 5—Auto Roster adjustments based on Injury Report (next player on depth chart auto selected for Out or Doubtful players) on Saturday
Step 6—Tipoff!

### Example 3

### Hockey (FIG. 7)

In this Hockey Example (also depicted as game 700 in FIG. 7), each weekly roster comprises positions on both offense and defense, each of which is linked to a pre-determined opposing position on defense and offense competing in the same organization (e.g., NHL) game as the aforementioned roster position. Play can incorporate any number of roster requirements; however, for demonstration purposes, this example uses an eight (8) player roster model comprising four (4) offensive and four (4) defensive players/positions. Once the selection process is complete, each Participant will have eight (8) players—four (4) on offense and four (4) on defense—and each player will be linked to the opposing teams player based on their exact position (e.g., C vs. G, W vs. D, etc.) within the same organization (NHL) game. The standard linked positions are as follows, but can include any variety therein:
   C1 vs. G1
   C2 vs. G2
   W1 vs. D1
   W2 vs. D2
   G1 vs. C1
   G2 vs. C2
   D1 vs. W1
   D2 vs. W2
In this Hockey Example, once the roster selection process of above is complete, both Participant 1 and Participant 2 must have the following four (4) offensive and four (4) defensive positions:

| | LINKED | |
|---|---|---|
| | POSI- | |
| Participant 1 Roster | TIONS | Participant 2 Roster |
| 1. Center | [symbol] | 9. Goalie |
| 2. Center | [symbol] | 10. Goalie |
| 3. Wing | [symbol] | 11. Defenseman |
| 4. Wing | [symbol] | 12. Defenseman |
| 5. Goalie | [symbol] | 13. Center |
| 6. Goalie | [symbol] | 14. Center |
| 7. Defenseman | [symbol] | 15. Wing |
| 8. Defenseman | [symbol] | 16. Wing |

In this Hockey Example, each of Participant 1's offensive positions (#s 1-4) is linked to each of Participant 2's defensive positions (#s 9-12) per the numerical order above and each of Participant 1's defensive positions (#s 5-8) is linked to each of Participant 2's offensive positions (#s 13-16). Each linked position (e.g., C & G) must come from the same NHL game whereby Participant 1's C is playing against Participant 2's G in the actual contest and vice versa for all matchups.
Using an NHL invention model with league play, the following provides a step-by-step example of creation and play process.
Step 1—Individual league creation and rules established (in this example, an eight weekly NHL game format with 8 roster positions per team is demonstrated) and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly as follows for a defined time period (e.g., from Tuesday to Saturday of given week), each pick triggers “push” notification to opponent via e-mail, text, or application message alert through the
Internet or other communications network system using established protocols currently existing or as may be established in the future, or any variation of the following depending on professional sports league schedule:
   Round 1: Participant 1 Smash Pick/Participant 2 Forced Pick
   Round 2: Participant 2 Smash Pick/Participant 1 Forced Pick
   Round 3: Participant 1 Smash Pick/Participant 2 Forced Pick
   Round 4: Participant 2 Smash Pick/Participant 1 Forced Pick
   Round 5: Participant 1 Smash Pick/Participant 2 Forced Pick
   Round 6: Participant 2 Smash Pick/Participant 1 Forced Pick
   Round 7: Participant 1 Smash Pick/Participant 2 Forced Pick
   Round 8: Participant 2 Smash Pick/Participant 1 Forced Pick
Step 5—Auto Roster adjustments based on Injury Report (next player on depth chart auto selected for Out or Doubtful players) on Saturday
Step 6—Faceoff!

### Example 4

### Soccer (FIG. 8)

In this Soccer Example (also depicted as game 800 in FIG. 8), each weekly roster comprises positions on both offense and defense, each of which is linked to a pre-determined opposing position on defense and offense competing in the same organization (e.g., MSL, English Premier League, Spanish Liga, German Bundesliga, Italian Serie A, French Ligue 1, Portoguese First Division, etc.) game as the aforementioned roster position. Play can incorporate any number of roster requirements; however, for demonstration purposes, this example uses an eight (8) player roster model comprising four (4) offensive and four (4) defensive players/positions. Once the selection process is complete, each Participant will have eight (8) players—four (4) on offense and four (4) on defense. Each player will be linked to the opposing teams player based on their exact position (e.g., Forward=F vs. Goalkeeper=G, Mid-Fielder=MF vs. Defenseman=D, etc.) within the same organization (designated soccer league as listed above) game. The standard linked positions are as follows, but can include any variety therein:
   F1 vs. G1
   F2 vs. G2
   MF1 vs. D1
   MF2 vs. D2
   G1 vs. F1
   G2 vs. F2
   D1 vs. MF1
   D2 vs. MF2
In this Soccer Example, once the roster selection process of above is complete, both Participant 1 and Participant 2 must have the following four (4) offensive and four (4) defensive positions:

| | LINKED | |
|---|---|---|
| User 1 Roster | POSITIONS | User 2 Roster |
| 1. Forward | [symbol] | 9. Goalie |
| 2. Forward | [symbol] | 10. Goalie |
| 3. Mid-Fielder | [symbol] | 11. Defenseman |
| 4. Mid-Fielder | [symbol] | 12. Defenseman |
| 5. Goalie | [symbol] | 13. Forward |
| 6. Goalie | [symbol] | 14. Forward |
| 7. Defenseman | [symbol] | 15. Mid-Fielder |
| 8. Defenseman | [symbol] | 16. Mid-Fielder |

In this Soccer Example, each of Participant 1's offensive positions (#s 1-4) is linked to each of Participant 2's defensive positions (#s 9-12) per the numerical order above and each of Participant 1's defensive positions (#s 5-8) is linked to each of Participant 2's offensive positions (#s 13-16). Each linked position (e.g., F & G) must come from the same league game whereby Participant 1's F is playing against Participant 2's G in the actual contest and vice versa for all matchups.
Using a league (see above aforementioned league possibilities) invention model with league play, the following provides a step-by-step example of creation and play process.
Step 1—Individual league creation and rules established (in this example, an eight weekly DESIGNATED SOCCER LEAGUE game format with 8 roster positions per team is demonstrated) and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly as follows for a defined time period (e.g., from Tuesday to Saturday of given week), each pick triggers “push” notification to opponent via e-mail, text, or application message alert through the Internet or other communications network system using established protocols currently existing or as may be established in the future, or any variation of the following depending on professional sports league schedule:
   Round 1: Participant 1 Smash Pick/Participant 2 Forced Pick
   Round 2: Participant 2 Smash Pick/Participant 1 Forced Pick
   Round 3: Participant 1 Smash Pick/Participant 2 Forced Pick
   Round 4: Participant 2 Smash Pick/Participant 1 Forced Pick
   Round 5: Participant 1 Smash Pick/Participant 2 Forced Pick
   Round 6: Participant 2 Smash Pick/Participant 1 Forced Pick
   Round 7: Participant 1 Smash Pick/Participant 2 Forced Pick
   Round 8: Participant 2 Smash Pick/Participant 1 Forced Pick
Step 5—Auto Roster adjustments based on Injury Report (next player on depth chart auto selected for Out or Doubtful players) prior to start of designated games.
Step 6—Kickoff!

### Example 5

### Baseball (FIG. 9)

In this Baseball Example (also depicted as game 900 in FIG. 9), gameplay and roster requirements differ because Baseball (and Cricket) are the only team sports where the full offense and defense do not take the field of play simultaneously. Instead, one player opposes the other full team at any given time. Therefore, this Baseball Example (sample embodiment) links the Starting and Relief Pitcher positions of one Major League Baseball (“MLB”) team against the Batter positions (so-called Designated Hitter and Field Positions) of the opposing MLB team. For the invention, each weekly roster must comprise all 9 Batter positions, whereby a selected MLB series (3- or 4-games for example) requires selection of multiple Pitchers from one MLB team in opposition to any other Batter (Field or DH) position. Thus, the Pitcher position is linked to those positions and vice versa.
Play can incorporate any number of roster requirements; however, for demonstration purposes, this example uses an 18 player roster model comprising nine (9) Pitchers and nine (9) Batter Positions. Once the selection process is complete, each Participant will a roster comprising 18 players—9 Pitchers and 9 Batters—and each player will be linked to the opposing teams player based on their specific position (e.g., Starting Pitcher (SP) or Relief Pitcher (RP) vs. First Baseman (1B), or Second Baseman (2B), or Third Baseman (3B) or Catcher (C) or Left Fielder (LF), or Right Fielder (RF) or Center Fielder (CF) or Designated Hitter(DH)) within the same organization (MLB) game. The standard linked positions are as follows, but can include any variety therein:
   SP1 vs. 1B, 2B, 3B, C, LF, RF, CF or DH
   SP2 vs. 1B, 2B, 3B, C, LF, RF, CF or DH (not previously chosen above)
   SP3 vs. 1B, 2B, 3B, C, LF, RF, CF or DH (not previously chosen above)
   SP4 vs. 1B, 2B, 3B, C, LF, RF, CF or DH (not previously chosen above)
   SP5 vs. 1B, 2B, 3B, C, LF, RF, CF or DH (not previously chosen above)
   SP6 vs. 1B, 2B, 3B, C, LF, RF, CF or DH (not previously chosen above)
   RP1 vs. 1B, 2B, 3B, C, LF, RF, CF or DH (not previously chosen above)
   RP2 vs. 1B, 2B, 3B, C, LF, RF, CF or DH (not previously chosen above)
   RP3 vs. 1B, 2B, 3B, C, LF, RF, CF or DH (not previously chosen above)
In this Baseball Example, roster requirements will also include a minimum number of players selected from each available MLB series of games (for example, in the above model, each MLB series requires 3 players to be on each invention users Roster). Once the selection process is complete both Participant 1 and Participant 2 will have the following sample rosters by position, choosing from the following representative sample of 3-game series'—Angels vs. Rangers, Mariners vs. Yankees, Reds vs. Nationals, Rays vs. Orioles, Tigers vs. A's and Braves vs. Cardinals):

| | LINKED | |
|---|---|---|
| User 1 Roster | POSITIONS | User 2 Roster |
| 1. Angels SP1 vs. Rangers | [symbol] | 19. Rangers 3B or other available batter |
| 2. Angels SP2 | [symbol] | 20. Rangers CF or other available batter |
| 3. Angels RP1 | [symbol] | 21. Rangers DH or other available batter |
| 4. Mariners SP3 vs. Yankees | [symbol] | 22. Yankees 1B or other available batter |
| 5. Mariners SP4 | [symbol] | 23. Yankees 2B or other available batter |
| 6. Mariners RP2 | [symbol] | 24. Yankees SS or other available batter |
| 7. Reds SP5 vs. Nationals | [symbol] | 25. Nationals C or other available batter |
| 8. Reds SP6 vs. Nationals | [symbol] | 26. Nationals LF or other available batter |
| 9. Reds RP3 vs. Nationals | [symbol] | 27. Nationals RF or other available batter |
| 10. Rays C or other available batter | [symbol] | 28. Orioles SP1 |
| 11. Rays LF or other available batter | [symbol] | 29. Orioles SP2 |
| 12. Rays DH or other available batter | [symbol] | 30. Orioles RP1 |
| 13. Tigers 1B vs. A's | [symbol] | 31. A's SP3 |
| 14. Tigers 3B or other available batter | [symbol] | 32. A's SP4 |
| 15. Tigers CF or other available batter | [symbol] | 33. A's RP2 |
| 16. Braves 2B or other available batter | [symbol] | 34. Cardinals SP5 |
| 17. Braves SS or other available batter | [symbol] | 35. Cardinals SP6 |
| 18. Braves RF or other available batter | [symbol] | 36. Cardinals RP3 |

In this Baseball Example, each of Participant 1's Pitcher positions (#s 1-9) is linked to each of Participant 2's Batter positions (#s 10-18) per the numerical order above and each of Participant 1's Batter positions (#s 19-27) is linked to each of Participant 2's Pitcher positions (#s 28-36). Each linked position (e.g., SP3 and in this example 1B) must come from the same MLB game series whereby Participant 1's SP3 is playing against Participant 2's 1B in the actual contest and vice versa for all matchups.
Using an MLB invention model with league play, the following provides a step-by-step example of creation and play process.
Step 1—Individual league creation and rules established (in this example, a six weekly MLB 3-game series format with 18 roster positions per team is demonstrated) and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly as follows for a defined time period (e.g., from Tuesday to Saturday of given week), each pick triggers “push” notification to opponent via e-mail, text, or application message alert through the Internet or other communications network system using established protocols currently existing or as may be established in the future, or any variation of the following depending on professional sports league schedule. Note when picking in Baseball, three (3) picks at a time are made such that if Participant 1 picks a Pitcher from one MLB team, he must in fact pick three Pitchers from that team and vice versa for Batters:
Round 1: Participant 1 three (3) Smash Picks/Participant 2 three (3) Forced Picks
Round 2: Participant 2 three (3) Smash Picks/Participant 1 three (3) Forced Picks
Round 3: Participant 1 three (3) Smash Picks/Participant 2 three (3) Forced Picks
Round 4: Participant 2 three (3) Smash Picks/Participant 1 three (3) Forced Picks
Round 5: Participant 1 three (3) Smash Picks/Participant 2 three (3) Forced Picks
Round 6: Participant 2 three (3) Smash Picks/Participant 1 three (3) Forced Picks
Step 5—Auto Roster adjustments based on Injury Report (next player on depth chart auto selected for Out or Doubtful players) on Saturday
Step 6—Play Ball!

### Example 6

### Cricket

In this Cricket Example, the game play and roster requirements differ because Cricket (and Baseball) are the only team sports where the full Offense and Defense do not take the field of play simultaneously. Instead, with Cricket, two batsmen—one at a time—opposes the other full team at any given time. Therefore, in this embodiment of the invention, Cricket links the Bowler (fast or spin) positions of one Cricket team against the Batsmen of the opposing Cricket team, the Wicket-keeper of one Cricket team against the Wicket-keeper of the opposing Cricket team, the All-rounders of one Cricket Team against the All-rounders of the opposing Cricket team. For individual invention game matches, each Participant's weekly roster must comprise (4) Batsmen, (2) All-rounders, (1) Wicket-keeper, and (4) Bowlers (consisting of (2) pace bowlers and (2) spin bowlers), whereby a selected English, Indian, Australian league (County or 20 Over League) match requires selection of Bowlers from one Cricket team in opposition to any other Batsmen position. Thus, the Bowler position is linked to Batsmen, Wicket-keeper to Wicket-keeper, All-rounder to All-Rounder.
Play can incorporate any number of roster requirements; however, for demonstration purposes, this example uses an 11 player roster model comprising four (4) Bowlers and four (4) Batsmen positions, one (1) Wicket-keeper, and two (2) All-rounders. Once the selection process is complete, each Participant's roster will comprise 11 players—4 Bowlers and 4 Batsmens, 1 Wicket-keeper, and 2 All-rounders—and each player will be linked to the opposing teams player based on their specific position (e.g., Bowler vs. Baseman, Wicket-keeper vs. Wicket-keeper, All-rounder vs. All-rounder) within the same organization (English, Australian, Indian County or limited over league play) match. The standard linked positions are as follows, but can include any variety therein:
   Batsmen1 vs. Bowler (Fast-Med Pace or Spin)
   Batsmen2 vs. Bowler (Fast-Med Pace or Spin)
   Batsmen3 vs. Bowler (Fast-Med Pace or Spin)
   Batsmen4 vs. Bowler (Fast-Med Pace or Spin)
   Bowler1 (Fast-Med Pace) vs. Batsmen
   Bowler2 (Fast-Med Pace) vs. Batsmen
   Bowler3 (Spin) vs. Batsmen
   Bowler4 (Spin) vs. Batsmen
   Wicket-keeper vs. Wicket-keeper
   All-rounder1 vs. All-rounder
   All-rounder2 vs. All-rounder
In this Cricket Example, roster requirements will also include a minimum number of players selected from each available designated league matches (for example, in the above model, each designated league match, in this case using the India Twenty20 League, requires at a minimum 2 players to be on each invention users Roster). Once the selection process is complete, both Participant 1 and Participant 2 will have the following sample rosters by position, choosing from Chennai Super Kings vs. Kings XI Punjab, Delhi Daredevils vs. Kolkata Knight Riders, Mumbai Indians vs. Pune Warriors, Rajasthan Royals vs. Royal Challengers Bangalore:

| User 1 | | | User 2 | | |
|---|---|---|---|---|---|
| Position | Player | Team | Position | Player | Team |
| Batsmen1 | Suresh Raina | Super Kings | Bowler (MF)1 | Ryan Harris | Kings X! |
| Batsmen2 | Virat Kohli | R. Challengers | Bowler (MF)2 | Amit Singh | Royals |
| Batsmen3 | Brad Hodge | Royals | Bowler (SP)3 | Syed Mohammed | R. Challengers |
| Batsmen4 | S. Tendulkar | Indians | Bowler (SP)4 | Ajanmtha Mendis | Warriors |
| All-rounder1 | Shane Watson | Royals | All-rounder1 | Andrew McDonald | R. Challengers |
| All-rounder2 | Ryan McLaren | Knight Riders | All-rounder2 | R van der Merwe | Daredevils |
| Wicketkeeper | M S Doni | Super Kings | Wicketkeeper | Adam Gilchrist | Kings XI |
| Bowler (MF)1 | Ajit Agakar | Daredevils | Batsmen1 | Gautam Gambhir | Knight Riders |
| Bowler (MF)2 | Lasith Malinga | Indians | Batsmen2 | Ross Taylor | Warriors |
| Bowler (SP)3 | Rahul Sharma | Warriors | Batsmen3 | Kieron Pollard | Indians |
| Bowler (SP)4 | Murali Kartik | Knight Riders | Batsmen4 | Vilander Sehwag | Daredevils |

In Cricket there are two models. Model One is a basic model where each player is awarded points for runs and wickets that make up the total score for both Participant 1 and Participant 2.
Model Two is a more complex method where the same scoring method in Model One is used; however, additional points are awarded for runs and wickets in true head-to-head matchups. For example if in the above roster example, Suresh Raina of the Chennai Super Kings scores runs against Ryan Harris, bonus points are awarded. Conversely, if Ryan Harris takes Suresh Raina's wicket, he receives bonus points.
Using the India Twenty20 League invention model with league play, the following provides a step-by-step example of creation and play process.
Step 1—Individual league creation and rules established and team schedules set.
Step 2—An electronic coin toss (or in League play the Home Team) determines which of the two Participants (identified here as Participant 1 and Participant 2) will pick first.
Step 3—Participant 1 wins the toss and chooses first.
Step 4—Round by round roster selection conducted weekly prior to actual Twenty20 matches (each pick triggers “push” notification to opponent via e-mail, text, or application message alert through the Internet or other communications network system using established protocols currently existing or as may be established in the future, or any variation of the following depending on professional sports league schedule.
Round 1: Participant 1 one (1) Smash Picks/Participant 2 one (1) Forced Picks
Round 2: Participant 2 one (1) Smash Picks/Participant 1 one (1) Forced Picks
Round 3: Participant 1 one (1) Smash Picks/Participant 2 one (1) Forced Picks
Round 4: Participant 2 one (1) Smash Picks/Participant 1 one (1) Forced Picks
Round 5: Participant 1 one (1) Smash Picks/Participant 2 one (1) Forced Picks
Round 6: Participant 2 one (1) Smash Picks/Participant 1 one (1) Forced Picks
Round 7: Participant 1 one (1) Smash Picks/Participant 2 one (1) Forced Picks
Round 8: Participant 2 one (1) Smash Picks/Participant 1 one (1) Forced Picks
Round 9: Participant 1 one (1) Smash Picks/Participant 2 one (1) Forced Picks
Round 10: Participant 2 one (1) Smash Picks/Participant 1 one (1) Forced Picks
Round 11: Participant 1 one (1) Smash Picks/Participant 2 one (1) Forced Picks
Step 5—Participant 1 or 2 may select replacement players before designed match deadline, where he/she may replace any player with a player from the same team and position not selected by his/her opponent. If no roster adjustment is made and a player is injured and out of the match, Auto Roster adjustments can be instituted based on Injury Report (next player on depth chart prior to matches starting.
Step 6—Play Ball!

### Example 7

### Tournament)

In this Tournament model Example, which represents a model for a broad range of sports tournaments (NFL, CFL and NCAA football, NBA and NCAA basketball, MLB baseball, soccer, hockey, cricket, etc.), a team-based selection process results in roster composition comprised of teams in a given tournament in addition to the player-based roster composition model option detailed in the other sport-specific models. In the team-based model, play can incorporate any number of roster requirements, however, for demonstration purposes we will use the NCAA Basketball Tournament and presume an 8 team roster model comprising eight (8) teams from each Region of the tournament's “field of 64” teams. Once the selection process is complete, each invention user will have 8 teams and each team will be linked to their opposing team in their respective bracket (e.g., #1 seed vs. #16, #2 vs. #15, #3 vs. #14, etc.) within the same Region (e.g., East, South, Midwest, West). The full sample of linked teams for an 8 team roster in a Regional “field of 64” bracket is as follows:
   #1 vs. #16
   #2 vs. #15
   #3 vs. #14
   #4 vs. #13
   #5 vs. #12
   #6 vs. #11
   #7 vs. #10
   #8 vs. #9
In the NCAA Basketball Tournament model above, once the roster selection process is complete both Participant 1 and Participant 2 must each have 8 teams, all of which are linked to their seeded opponent per the above. Points are awarded to each Participant based on a variety of optional metrics, with a team winning their game being the most typical and incorporating an assigned value for a win, round-by-round in the tournament. Advancement into later rounds of the tournament is based on head-to-head results vs. other Participants in either a point differential measurement, or a game-by-game won/loss record, or any other metric. This model can also be combined with a player-based roster selection model which can be used in earlier or later rounds in any combination (e.g., in NCAA Basketball Tournament model, Participants pick their team rosters which are fixed until the National Semi-Finals, whereupon one Participant from each of 4 Regions advances based on won/loss record within Region and then the gameplay converts to a player-based model, whereby Participant 1 plays Participant 2 and Participant 3 plays Participant 4 by picking rosters per the player gameplay model as articulated in the Basketball gameplay rules.)
In the NCAA Basketball Tournament model, each of Participant 1's teams is linked to each of Participant 2's teams such that if Participant 1 selects Seed #5, Participant 2 must select that team's opponent, Seed #12 and so on until all 16 teams are claimed, 8 on each Participants roster.
Using an NCAA Basketball Tournament invention model with pool play, the following provides a step-by-step example of creation and play process.
Step 1—Individual pool of Participants creation and rules established and Participant matchup schedules set.
Step 2—An electronic coin toss (or random drawing) determines which of the two Participants is the Home team and thus will pick first.
Step 3—Participant 1 wins the toss (or is previously identified as the Home Team) and chooses first.
Step 4—Participant 2 makes a Forced Pick of the team playing Participant 1's first pick in the respective Region's first (now referred to as second due to play-in games) round.
Step 5—Participant 2 makes another pick of any remaining team in the Region.
Step 6—Participant 1 makes a Forced Pick per the previously defined rules.
Step 7—Participant 2 makes another pick of any remaining team in the Region (this second consecutive “lead” pick is to neutralize the “home field advantage” primarily because the NCAA Basketball Tournament itself is played on neutral courts.
Step 8—Participant 1 makes another Forced Pick.
Step 9—Participant 1 now makes another “lead” pick and the picking now alternates until all 16 teams in the specific Region are chosen while simultaneously, other Participants are doing the same process in the other Regions. Each pick triggers a “push” notification to Participant's opponent via e-mail, text, or application message alert through the Internet or other communications network system using established protocols currently existing or as may be established in the future. Below is a round-by-round articulation of the selection process:
   Round 1: Participant 1 Smash Pick/Participant 2 Forced Pick
   Round 2: Participant 2 Smash Pick/Participant 1 Forced Pick
   Round 3: Participant 2 Smash Pick/Participant 1 Forced Pick
   Round 4: Participant 1 Smash Pick/Participant 2 Forced Pick
   Round 5: Participant 2 Smash Pick/Participant 1 Forced Pick
   Round 6: Participant 1 Smash Pick/Participant 2 Forced Pick
   Round 7: Participant 2 Smash Pick/Participant 1 Forced Pick
   Round 8: Participant 1 Smash Pick/Participant 2 Forced Pick
Step 10—Tipoff!

This Description is neither intended nor should it be construed as being representative of the full extent and scope of the present invention.

The images in the drawings are simplified for illustrative purposes and are not depicted to scale. To facilitate understanding, identical reference numerals are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore numerous modifications may be made to the illustrative embodiments and other arrangements may be devised without departing from the spirit and scope of the present invention. It has been contemplated that features or steps of one embodiment may be incorporated in other embodiments of the invention without further recitation.

1. A method of playing a fantasy sports game, comprising:
determining a sport and an organization of the sport upon which the fantasy sports game is based, said organization comprising an at least two teams, wherein the at least two teams are each comprised of an at least one offensive player and an at least one defensive player and wherein each player plays an established player position on the team;
selecting an at least one scheduled game between two teams of the organization from which players from said teams may be drafted by an at least two participants of the fantasy sports game to create a fantasy team for each participant;
determining a fantasy team roster composition format, wherein said roster composition format requires that each fantasy team be comprised of an equal number of offensive and defensive player positions; and
conducting an asynchronous fantasy draft by participants of offensive and defensive players from the teams competing in the at least one scheduled game until each participant's fantasy team roster is filled according to the roster composition format;
wherein the fantasy teams of at least two participants compete against each other in a fantasy game; wherein points are awarded to each fantasy team according to a pre-determined scoring format that awards points to fantasy team players based on a performance of the players of the sport in the at least one scheduled game; and wherein the fantasy team compiling a greater amount of points at a conclusion of the fantasy game is a winner of the game.

2. The method of claim 1, wherein the fantasy game is played by two participants, a first participant and a second participant.

3. The method of claim 2, wherein offensive player positions and defensive player positions of the roster composition format are linked with each other in a pre-determined fashion so that a first draft selection of a team player in a scheduled game by the first participant for a respective player position requires that the second participant make a forced draft selection of a team player in the linked player position in the same scheduled game.

4. The method of claim 3, wherein the roster composition format requires that the participants alternate turns in the draft between a first draft selection and a forced draft selection.

5. The method of claim 3, wherein the first draft selection is comprised of either an offensive player or defensive player.

6. The method of claim 3, wherein the forced draft selection comprises a pre-determined player position from the team that is opposing the team in the scheduled game of the player the subject of the first draft selection.
